(19) United States
(12) Patent Application Publication
(10) Pub. No.: US 2025/0356197 A1
(43) Pub. Date: Nov. 20, 2025

(54) SYSTEMS AND METHODS FOR DETECTION OF HALLUCINATION IN LARGE LANGUAGE MODELS

(71) Applicant: JPMORGAN CHASE BANK, N.A., New York, NY (US)

(72) Inventors: Najah GHALYAN, Wayne, NJ (US); Leandro RIOS, Capital Federal (AR); Tatiana BADARACCO, Caba (AR); Sean MORAN, London (GB)

(21) Appl. No.: 18/665,178

(22) Filed: May 15, 2024

(51) Int. Cl. G06N 3/0895

(52) U.S. Cl. CPC G06N 3/0895

(57) ABSTRACT

Systems and methods for detection of hallucination in large language models are disclosed. According to an embodiment, a method may include: (1) receiving, by a computer program, a plurality of input texts, wherein each input text is a prompt for a large language model (LLM) and may include a slight perturbation from an initial input text; (2) generating, by the computer program and for each of the plurality of input texts, an input embedding vector; (3) providing, by the computer program, each input text to a large language model (LLM); (4) receiving, by the computer program and for each input text from the LLM, an output text; (5) generating, by the computer program and for each of the plurality of output texts, an output embedding vector; and (6) generating, by the computer program, a hallucination metric based on the input embedding vectors and the output embedding vectors.

### BACKGROUND OF THE INVENTION

### 1. Field of the Invention

Embodiments generally relate to systems and methods for detection of hallucination in large language models.

### 2. Description of the Related Art

The use of large language models (LLMs) is very popular. LLMs, however, occasionally generate responses that are incorrect, nonsensical, or not real in response to a prompt. This phenomenon is referred to as “hallucinations.”

Hallucinations may be obvious in certain scenarios, such as when the response is yes or no, but less easy to detect in other scenarios, especially where the response includes some accurate details and some inaccurate details. Quantifying hallucinations in the later scenario may be particularly challenging.

### SUMMARY OF THE INVENTION

Systems and methods for detection of hallucination in large language models are disclosed. According to an embodiment, a method may include: (1) receiving, by a computer program, a plurality of input texts, wherein each input text is a prompt for a large language model (LLM) and may include a slight perturbation from an initial input text; (2) generating, by the computer program and for each of the plurality of input texts, an input embedding vector; (3) providing, by the computer program, each input text to a large language model (LLM); (4) receiving, by the computer program and for each input text from the LLM, an output text; (5) generating, by the computer program and for each of the plurality of output texts, an output embedding vector; and (6) generating, by the computer program, a hallucination metric based on the input embedding vectors and the output embedding vectors.

In one embodiment, the step of receiving the plurality of input texts may include: receiving, by the computer program, the initial input text; and receiving, by the computer program, a plurality of perturbed input texts. The plurality of input texts may include the initial input text and the plurality of perturbed input texts.

In one embodiment, the plurality of perturbed input texts are generated by the LLM.

In one embodiment, the input embedding vectors for the plurality of perturbed input texts are within a predetermined value of the input embedding vector for the initial input text.

In one embodiment, the input texts are received as natural language.

In one embodiment, the hallucination metric may be calculated using the following equation:

$$\frac{1}{M} {\sum }_{1}^{M} \frac{‖ {y}_{i} - {y}_{j} ‖}{‖ {x}_{i} - {x}_{j} ‖}$$

where M is a number of the plurality of input texts, y is the output embedding vector, and x is the input embedding vector.

In one embodiment, the hallucination metric may be calculated using the following equation:

$$\frac{1}{M} {\sum }_{i} ‖ {y}_{i} - {y}_{j} ‖$$

where ∥xᵢ-xⱼ∥ is less than a fixed δ, M is a number of the plurality of input texts, y is the output embedding vector, x is the input embedding vector, and δ is a maximum change between two of the input embedding vectors.

According to another embodiment, a method may include: (1) receiving, by a computer program, a plurality of samples, each sample comprising a plurality of input texts, wherein each input text is a prompt for a large language model (LLM) and may include a slight perturbation from the other input texts; (2) for each of the plurality of samples: generating, by the computer program and for each of the plurality of input texts, an input embedding vector; providing, by the computer program, each input text to a large language model (LLM); receiving, by the computer program and for each input text from the LLM, an output text; and generating, by the computer program and for each of the plurality of output texts, an output embedding vector; and (3) generating, by the computer program, a model hallucination metric based on the input embedding vectors and the output embedding vectors.

In one embodiment, the step of receiving, by a computer program, a plurality of samples may include: for each sample: receiving, by the computer program, an initial input text; and receiving, by the computer program, a plurality of perturbed input texts. The plurality of input texts may include the initial input text and the plurality of perturbed input texts.

In one embodiment, the plurality of perturbed input texts are generated by the LLM.

In one embodiment, the input embedding vectors for the plurality of perturbed input texts are within a predetermined value of the input embedding vector for the initial input text.

In one embodiment, the input texts are received as natural language.

In one embodiment, the model hallucination metric may be calculated using the following equation:

$$\frac{1}{N} {\sum }_{1}^{N} {v}_{j} , {v}_{j} = \frac{1}{M} {\sum }_{1}^{M} \frac{‖ {y}_{i} - {y}_{j} ‖}{‖ {x}_{i} - {x}_{j} ‖}$$

where M is a number of the plurality of input texts, y is the output embedding vector, x is the input embedding vector, and N is a number of the plurality of samples.

In one embodiment, the model hallucination metric may be calculated using the following equation:

$$\frac{1}{N} {\sum }_{1}^{N} {v}_{j} , {v}_{j} = \frac{1}{M} {\sum }_{1}^{M} ‖ {y}_{i} - {y}_{j} ‖$$

where ∥xᵢ-xⱼ∥ is less than a fixed δ, M is a number of the plurality of input texts, y is the output embedding vector, x is the input embedding vector, N is a number of the plurality of samples, and δ is a maximum change between two of the input embedding vectors.

According to another embodiment, a non-transitory computer readable storage medium may include instructions stored thereon, which when read and executed by one or more computer processors, cause the one or more computer processors to perform steps comprising: receiving a plurality of input texts, wherein each input text is a prompt for a large language model (LLM) and may include a slight perturbation from an initial input text, and the input texts are received as natural language; generating an input embedding vector; providing each input text to a large language model (LLM); receiving, for each input text and from the LLM, an output text; generating, for each of the plurality of output texts, an output embedding vector; and generating a hallucination metric based on the input embedding vectors and the output embedding vectors.

In one embodiment, the instructions for receiving the plurality of input texts, which when read and executed by one or more computer processors, may cause the one or more computer processors to perform steps comprising: receiving the initial input text; and receiving a plurality of perturbed input texts. The plurality of input texts may include the initial input text and the plurality of perturbed input texts.

In one embodiment, the plurality of perturbed input texts are generated by the LLM.

In one embodiment, the input embedding vectors for the plurality of perturbed input texts are within a predetermined value of the input embedding vector for the initial input text.

In one embodiment, the hallucination metric may be calculated using the following equation:

$$\frac{1}{M} {\sum }_{1}^{M} \frac{‖ {y}_{i} - {y}_{j} ‖}{‖ {x}_{i} - {x}_{j} ‖}$$

where M is a number of the plurality of input texts, y is the output embedding vector, and x is the input embedding vector.

In one embodiment, the hallucination metric may be calculated using the following equation:

$$\frac{1}{M} {\sum }_{i} ‖ {y}_{i} - {y}_{j} ‖$$

where ∥xᵢ-xⱼ∥ is less than a fixed δ, M is a number of the plurality of input texts, y is the output embedding vector, x is the input embedding vector, and δ is a maximum change between two of the input embedding vectors.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for detection of hallucination in large language models according to an embodiment;

FIG. 2 depicts a method for detection of hallucination in large language models according to an embodiment;

FIG. 3 depicts a method for detection of hallucination in large language models according to another embodiment;

FIG. 4 depicts an exemplary computing system for implementing aspects of the present disclosure.

### DETAILED DESCRIPTION OF PREFERRED EMBODIMENTS

Embodiments generally relate to systems and methods for detection of hallucination in large language models.

Embodiments may use the concept of “Input-Output Stability” to identify hallucinations in LLM and other artificial intelligence models. Input-Output Stability is a concept that is often used with dynamic systems, such as control systems. For a system to be input-output stable, a small deviation in input results in a small deviation in the output, while a system that is not input-output stable will produce a large deviation in the output. A description of input-output stability is disclosed in E. Sontag and Y. Wang, “A notion of input to output stability,” 1997 European Control Conference (ECC), Brussels, Belgium, 1997, pp. 3862-3867, the disclosure of which is hereby incorporated, by reference, in its entirety.

Embodiments described herein may use input-output measurements of LLMs to detect hallucinations based on the correlation between input-output stable behavior of the LLM and its robustness to produce hallucinations.

Embodiments may use the input-output stability of LLMs to detect sample-based hallucinations, and/or model-based hallucinations.

Embodiments may also use the input-output stability of LLMs to quantify the robustness/proneness of LLMs to hallucinations.

Embodiments may be based on the intuition that the information provided by an LLM based on factual information would be typically consistent. In contrast, hallucinations are generally not based on factual information and can be inconsistent. Therefore, a hallucinating response can significantly change if the prompts are slightly perturbed, potentially showing input-output non-stable behavior.

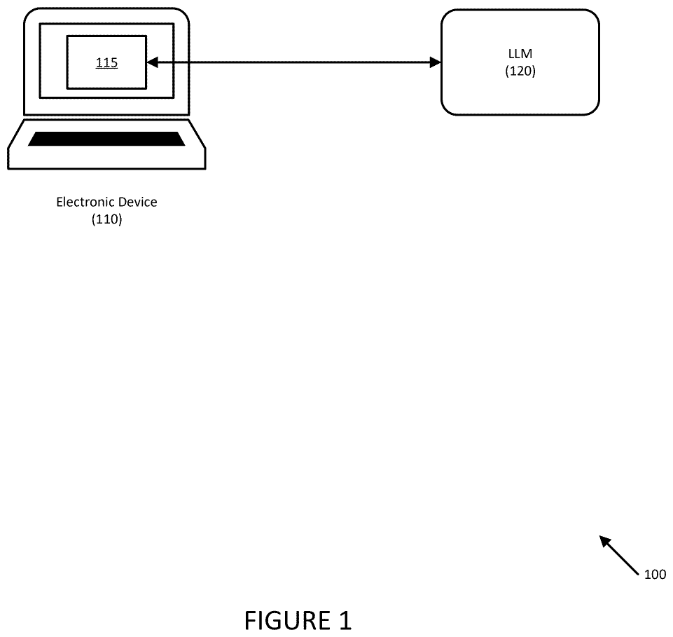

FIG. 1 depicts a system for detection of hallucination in large language models according to an embodiment. System 100 may include electronic device 110, which may be a server (e.g., physical and/or cloud-based), a computer (e.g., workstation, desktop, laptop, notebook, tablet, etc.) a smart device (e.g., smartphone, smart watch, etc.), and Internet of Things (IoT) appliance, etc. Electronic device 110 may execute hallucination detection computer program 115.

Hallucination detection computer program 115 may interface with one or more LLMs 120. Hallucination detection computer program may receive input text in natural language format and may use the input text to detect hallucinations in LLM(s) 120 on a per-sample basis (e.g., how LLM 120 responds to perturbations in samples) and/or on a per-model basis (e.g., an average hallucination score over a set of outputs).

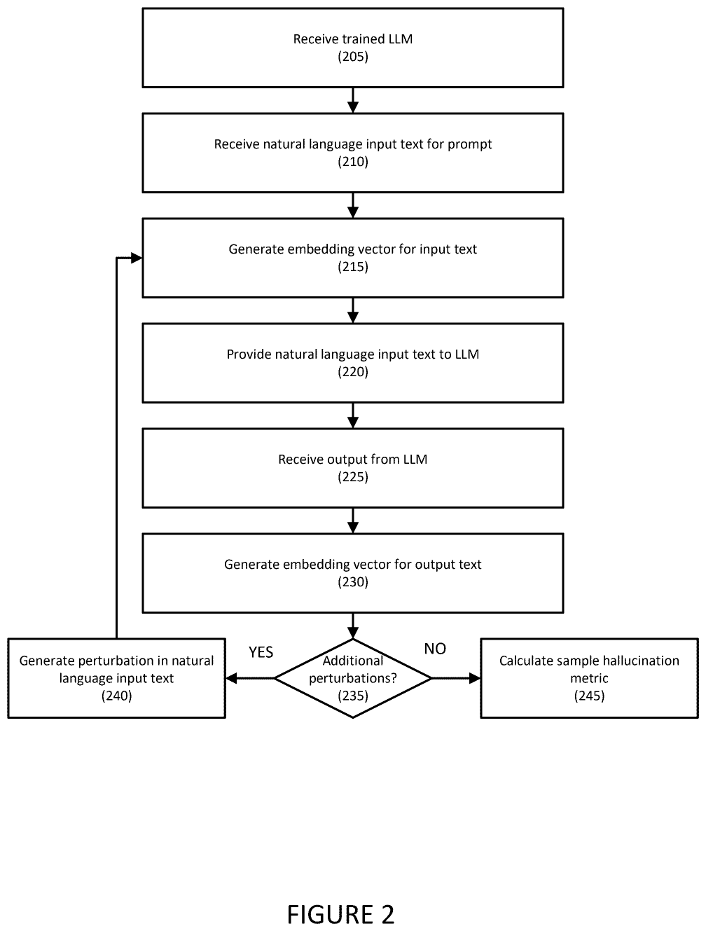

Referring to FIG. 2, a method for detection of hallucination in large language models is disclosed according to an embodiment. For example, the hallucination metric may be at the sample (e.g., a collection of similar input text) level.

In step 205, a LLM may be trained with training data. Examples of LLMs may include OpenAI GPT-3, BERT, ROBERTa, T5, etc.

In step 210, a computer program, such as a hallucination detection computer program, may receive input text in a natural language format for prompting the LLM.

In step 215, the computer program may generate an embedding vector for the input text. For example, using any suitable technique, the input text may be converted to a numerical value.

In step 220, the computer program may provide the natural language input text to the LLM as a prompt, and in step 225, the LLM may respond with an output text.

In step 230, the computer program may generate an embedding vector for the output text. In one embodiment, the same technique that was used to generate the embedding vector for the input text may be used to generate the embedding vector for the output text.

In step 235, the computer program may determine if additional perturbed samples are needed. In one embodiment, the number of perturbed samples may be specified by the user. If there are, in step 240, the computer program may generate a perturbation in the natural language input text. For example, the computer program may make a slight change in the text, such as by changing the order of the words in the input text, using synonyms for words in the input text, etc.

In one embodiment, a LLM may be prompted for similar input texts to the input text, which may be an initial input text. If the embedding vectors for one of the similar input texts generated by the LLM are significantly spaced from the embedding vector for the initial input text, the similar input text may be discarded. The spacing may be based on a predetermined value, which may be set by the user.

In one embodiment, the embedding vectors for the input text and the similar input texts may be within a predetermined value, or distance, of each other to be similar.

In another embodiment, the perturbation may be implemented manually.

The process may then be repeated with the perturbed input text.

If there are no additional perturbations, in step 245, the computer program may calculate a hallucination metric for the sample based on the perturbation in the samples. For example, the computer program may calculate the hallucination metric, vⱼ, using the following equation:

$${v}_{j} = \frac{1}{M} {\sum }_{1}^{M} \frac{‖ {y}_{i} - {y}_{j} ‖}{‖ {x}_{i} - {x}_{j} ‖}$$

where M is the number of perturbed samples, y is output text's embedding vector, and x is the input text's embedding vector.

Alternatively, or in addition, the hallucination metric, vⱼ, may be calculated using the following equation:

$${v}_{j} = \frac{1}{M} {\sum }_{i} ‖ {y}_{i} - {y}_{j} ‖ , where ‖ {x}_{i} - {x}_{j} ‖$$

is always less than a fixed δ.
where δ is the maximum change between embedding vectors of input text variations that has slight change in the text meaning. This may be determined by generating various input texts with similar meanings and finding the maximum of their embedding vectors difference.

In one embodiment, the value for & may be set by the user.

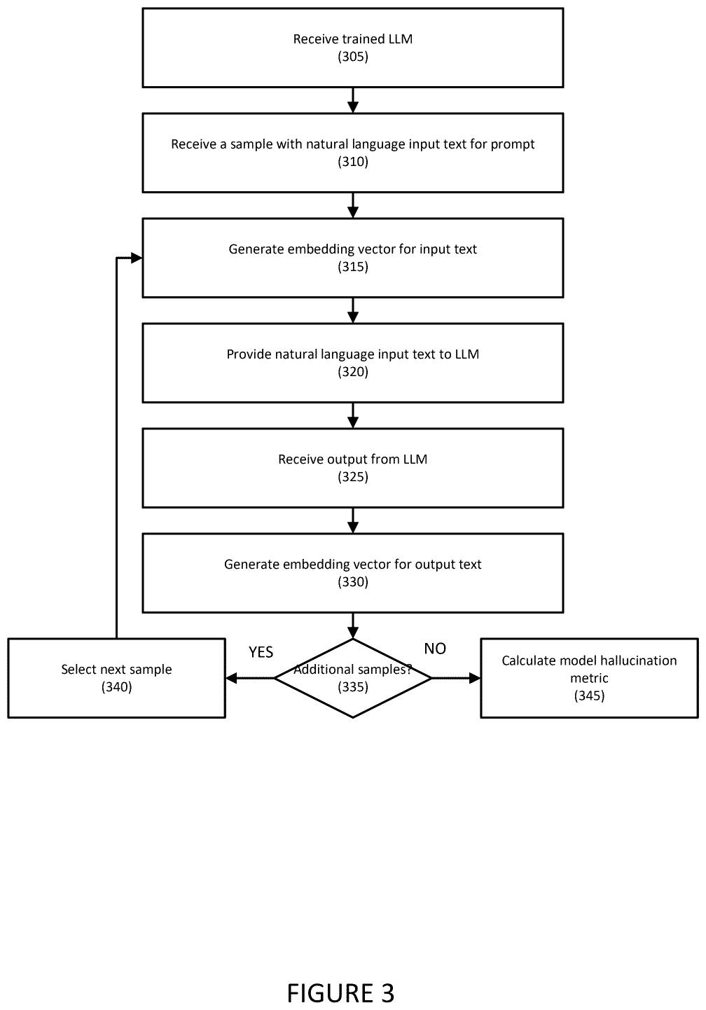

Referring to FIG. 3, a method for a method for detection of hallucination in large language models is disclosed according to another embodiment. For example, the hallucination metric may be at the model level (e.g., the hallucinations for the model for a plurality of samples).

In step 305, a LLM may be trained with training data. Examples of LLMs may include OpenAI GPT-3, BERT, ROBERTa, T5, etc.

In step 310, a computer program, such as a hallucination detection computer program, may receive input text in a natural language format for prompting the LLM. In one embodiment, an initial input text may be received, and additional input texts may be generated using an LLM. In another embodiment, the input texts may be received from a user.

In one embodiment, the embedding vectors for the input text and the similar input texts may be within a predetermined value, or distance, of each other to be similar.

In step 315, the computer program may generate embedding vectors for the input text. For example, using any suitable technique, the input text may be converted to a numerical value.

In step 320, the computer program may provide the natural language input texts to the LLM as a prompt, and in step 325, the LLM may respond with an output text for each input text.

In step 330, the computer program may generate an embedding vector for each output text. In one embodiment, the same technique that was used to generate the embedding vector for the input text may be used to generate the embedding vector for the output text.

In step 335, the computer program may determine if additional samples are needed. In one embodiment, the number of samples, and the input text for each sample, may be specified by the user. If there are, in step 340, the computer program may select the next input in natural language input text.

If there are no additional samples, in step 345, the computer program may calculate a hallucination metric for the model based on the different samples. For example, the computer program may calculate the model hallucination metric, v, using the following equation:

$$v = \frac{1}{N} {\sum }_{1}^{N} {v}_{j} , {v}_{j} = \frac{1}{M} {\sum }_{1}^{M} \frac{‖ {y}_{i} - {y}_{j} ‖}{‖ {x}_{i} - {x}_{j} ‖}$$

where M is the number of perturbed samples, y is output text's embedding vector, x is the input text's embedding vector, and N is the number of samples. For example, in each sample-level hallucination test, there are M input-output variations.

Alternatively, or in addition, the model hallucination metric, v, may be calculated using the following equation:

$$v = \frac{1}{N} {\sum }_{1}^{N} {v}_{j} , {v}_{j} = \frac{1}{M} {\sum }_{1}^{M} ‖ {y}_{i} - {y}_{j} ‖ ,$$

where ∥xᵢ-xⱼ∥ is always less than a fixed δ.

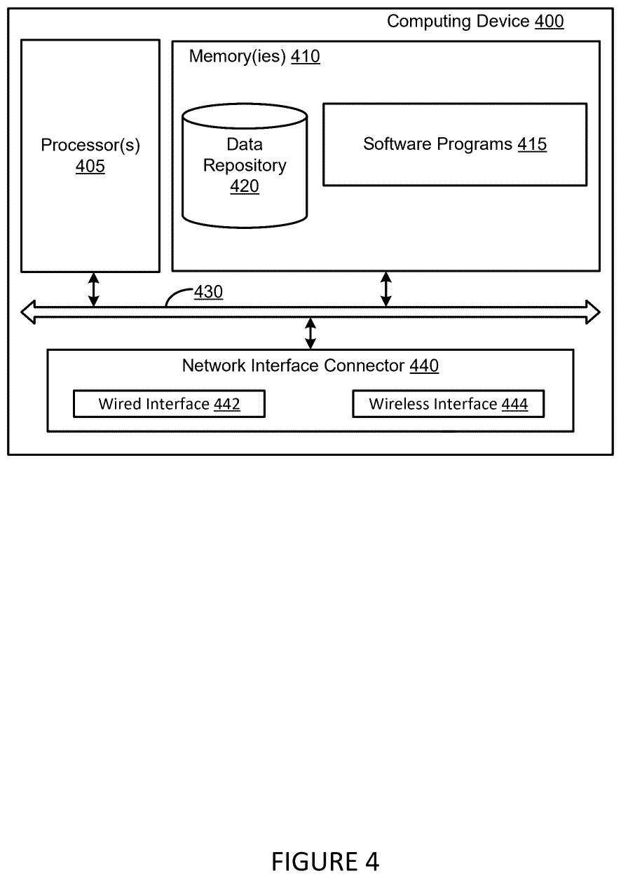

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program, a plurality of input texts, wherein each input text is a prompt for a large language model (LLM) and comprises a slight perturbation from an initial input text;
generating, by the computer program and for each of the plurality of input texts, an input embedding vector;
providing, by the computer program, each input text to a large language model (LLM);
receiving, by the computer program and for each input text from the LLM, an output text;
generating, by the computer program and for each of the plurality of output texts, an output embedding vector; and
generating, by the computer program, a hallucination metric based on the input embedding vectors and the output embedding vectors.

2. The method of claim 1, wherein the step of receiving the plurality of input texts comprises:
receiving, by the computer program, the initial input text; and
receiving, by the computer program, a plurality of perturbed input texts;
wherein the plurality of input texts comprises the initial input text and the plurality of perturbed input texts.

3. The method of claim 2, wherein the plurality of perturbed input texts are generated by the LLM.

4. The method of claim 3, wherein the input embedding vectors for the plurality of perturbed input texts are within a predetermined value of the input embedding vector for the initial input text.

5. The method of claim 1, wherein the input texts are received as natural language.

6. The method of claim 1, wherein the hallucination metric is calculated using the following equation:
$$\frac{1}{M} {\sum }_{1}^{M} \frac{‖ {y}_{i} - {y}_{j} ‖}{‖ {x}_{i} - {x}_{j} ‖}$$
where M is a number of the plurality of input texts, y is the output embedding vector, and x is the input embedding vector.

7. The method of claim 1, wherein the hallucination metric is calculated using the following equation:
$$\frac{1}{M} {\sum }_{i} ‖ {y}_{i} - {y}_{j} ‖$$
where ∥xᵢ-xⱼ∥ is less than a fixed δ, M is a number of the plurality of input texts, y is the output embedding vector, x is the input embedding vector, and δ is a maximum change between two of the input embedding vectors.

8. A method, comprising:
receiving, by a computer program, a plurality of samples, each sample comprising a plurality of input texts, wherein each input text is a prompt for a large language model (LLM) and comprises a slight perturbation from the other input texts;
for each of the plurality of samples:
generating, by the computer program and for each of the plurality of input texts, an input embedding vector;
providing, by the computer program, each input text to a large language model (LLM);
receiving, by the computer program and for each input text from the LLM, an output text; and
generating, by the computer program and for each of the plurality of output texts, an output embedding vector; and
generating, by the computer program, a model hallucination metric based on the input embedding vectors and the output embedding vectors.

9. The method of claim 8, wherein the step of receiving, by a computer program, a plurality of samples comprises:
for each sample:
receiving, by the computer program, an initial input text; and
receiving, by the computer program, a plurality of perturbed input texts;
wherein the plurality of input texts comprises the initial input text and the plurality of perturbed input texts.

10. The method of claim 9, wherein the plurality of perturbed input texts are generated by the LLM.

11. The method of claim 10, wherein the input embedding vectors for the plurality of perturbed input texts are within a predetermined value of the input embedding vector for the initial input text.

12. The method of claim 8, wherein the input texts are received as natural language.

13. The method of claim 8, wherein the model hallucination metric is calculated using the following equation:
$$\frac{1}{N} {\sum }_{1}^{N} {v}_{j} , {v}_{j} = \frac{1}{M} {\sum }_{1}^{M} \frac{‖ {y}_{i} - {y}_{j} ‖}{‖ {x}_{i} - {x}_{j} ‖}$$
where M is a number of the plurality of input texts, y is the output embedding vector, x is the input embedding vector, and N is a number of the plurality of samples.

14. The method of claim 8, wherein the model hallucination metric is calculated using the following equation:
$$\frac{1}{N} {\sum }_{1}^{N} {v}_{j} , {v}_{j} = \frac{1}{M} {\sum }_{1}^{M} ‖ {y}_{i} - {y}_{j} ‖$$
where ∥xᵢ-xⱼ∥ is less than a fixed δ, M is a number of the plurality of input texts, y is the output embedding vector, x is the input embedding vector, and δ is a maximum change between two of the input embedding vectors.

15. A non-transitory computer readable storage medium, including instructions stored thereon, which when read and executed by one or more computer processors, cause the one or more computer processors to perform steps comprising:
receiving a plurality of input texts, wherein each input text is a prompt for a large language model (LLM) and comprises a slight perturbation from an initial input text, and the input texts are received as natural language;
generating an input embedding vector;
providing each input text to a large language model (LLM);
receiving, for each input text and from the LLM, an output text;
generating, for each of the plurality of output texts, an output embedding vector; and
generating a hallucination metric based on the input embedding vectors and the output embedding vectors.

16. The non-transitory computer readable storage medium of claim 15, wherein the including instructions for receiving the plurality of input texts, which when read and executed by one or more computer processors, cause the one or more computer processors to perform steps comprising
receiving the initial input text; and
receiving a plurality of perturbed input texts;
wherein the plurality of input texts comprises the initial input text and the plurality of perturbed input texts.

17. The non-transitory computer readable storage medium of claim 16, wherein the plurality of perturbed input texts are generated by the LLM.

18. The non-transitory computer readable storage medium of claim 17, wherein the input embedding vectors for the plurality of perturbed input texts are within a predetermined value of the input embedding vector for the initial input text.

19. The non-transitory computer readable storage medium of claim 15, wherein the hallucination metric is calculated using the following equation:
$$\frac{1}{M} {\sum }_{1}^{M} \frac{‖ {y}_{i} - {y}_{j} ‖}{‖ {x}_{i} - {x}_{j} ‖}$$
where M is a number of the plurality of input texts, y is the output embedding vector, and x is the input embedding vector.

20. The non-transitory computer readable storage medium of claim 15, wherein the hallucination metric is calculated using the following equation:
$$\frac{1}{M} {\sum }_{i} ‖ {y}_{i} - {y}_{j} ‖$$
where ∥xᵢ-xⱼ∥ is less than a fixed δ, M is a number of the plurality of input texts, y is the output embedding vector, x is the input embedding vector, and δ is a maximum change between two of the input embedding vectors.
